(19) United States
(12) Patent Application Publication
(10) Pub. No.: US 2006/0211383 A1
(43) Pub. Date: Sep. 21, 2006

(54) Push-to-talk wireless telephony

(76) Inventors: Derek L. Schwenke, Marlborough, MA (US); Brent Harsham, Newton, MA (US); Bent Schmidt-Nielsen, Lexington, MA (US); Charles Rich, Newton, MA (US); Christopher H. Lee, Arlington, MA (US)

Correspondence Address: Patent Department;Mitsubishi Electric Research Laboratories, Inc., 201 Broadway, Cambridge, MA, 02139, US

(21) Appl. No.: 11/084,383

(22) Filed: Mar. 18, 2005

(51) Int. Cl. H04B 1/38; H04B 7/00; H04Q 7/20

(52) U.S. Cl. 455/90.2; 455/518

(57) ABSTRACT

In a cellular network, a cell phone transmits a continuous voice signal over a voice channel to a server. The cell phone can also generate events, the events including on events and off events. The events can be time-stamped. The events are transmitted as a data signal over a data channel of the network to the server. In the server, only segments of the voice signal that substantially correspond to a particular on event and a following off event are converted by an automated speech recognition engine. The converted signal can be further processed by a dialog manager that generates speech signals for the cell phone in response to the converted signal.

### FIELD OF THE INVENTION

This invention relates generally to wireless telephony, and more particularly to push-to-talk (PTT) telephony.

### BACKGROUND OF THE INVENTION

In the prior art, push-to-talk (PTT) is used in wireless communications to select when a voice signal is transmitted. Frequently, a button on a microphone provides the PTT function. PTT is also useful when the voice signal is further processed by a speech recognition system. PTT reduces speech recognition errors due to noise.

FIG. 2 shows a prior art, single channel PTT system 200. A client 210 is connected to a server 220 by a voice channel 201. A single switch 230 performs the PPT function. That type of system enables the voice channel 201 when the PTT is ‘on’, and disables the channel when PTT is ‘off’. In that system, the voice channel is intermittently enabled. It is desired to provide PTT for a device that requires continuous operation of the voice channel when in use, such as a cellular telephone.

FIG. 3 shows a prior art switched channel system 300 with two switches 331-332. The PTT switches control the mode of operation, either a voice or a data signal on the same switched channel 301. In that system, the channels transmits either voice or data signals. It is desired to provide PTT for a device that can transmit voice and data signals concurrently, such as a cellular telephone.

FIG. 4 shows a prior art multiplexed channel system 400 where voice and data signal share the same channel 401 having a fixed latency. It is desired to provided PTT for a device that uses different channels for voice and data signals, and in which the latencies of the voice and data channels are different, such as a cellular telephone.

Other related prior art is described in U.S. Patent Application 20040100987 “Method for managing two-way alternate communication in semi-duplex mode through a packet switching transport network,” and U.S. Pat. No. 6,741,952, “Instrument timing using synchronized clocks” and U.S. Pat. No. 6,748,053, “Relay for personal interpreter.”

### SUMMARY OF THE INVENTION

The invention provides push-to-talk (PTT) for conventional wireless telephony devices, such as cellular telephones (cell phones) that are otherwise not designed to support PTT. The PTT according to the invention concurrently uses both a voice and data channel of a wireless network, such as a cellular telephone network.

In a cell phone, a microphone is always ‘on’ when the cell phone is in use. In conventional cell phones there is no capability to turn the microphone ‘off’ to provide a true PTT function. Consequently, the cell phone continuously transmits a voice signal on a voice channel when in use. This becomes a particular problem if the voice signal is to be processed by an automatic speech recognition system.

Therefore, the invention provides the cell phone with a PTT button that signals PTT ‘on’ and ‘off’ events. The events can be time-stamped according to a clock of the cell phone. Alternatively, the ‘on’ and ‘off’ events form a sequence of pairs without a time-stamp.

In any case, unlike the prior art, the events and optional time-stamps are transmitted as message, e.g., data packets, on a data channel of the cellular telephone network, which is separate from the voice channel. It should be noted that the voice and data channel can have different bandwidth and latency characteristics.

A server connected to the network receives the voice and data signals. The server includes an automatic speech recognition (ASR) system and a clock. The clock can be synchronized with the clock of the cell phone, although this is not a requirement to work the invention.

The server correlates the PTT ‘on’ and ‘off’ events that have been received and selects segments from the voice buffer that fall inside PTT ‘on’ windows for processing and discards segments that fall in ‘off’ windows.

The ASR receives and processes the ‘on’ segments and generates corresponding text. The text can be analyzed by a dialog manager, which also provides results in the form of text. The text results are converted to speech and sent back to the cell phone.

The server can also generate a short “tone” to indicate when the user is to speak. This prevents distractions and miscommunications because the cell phone and the ASR system and application operate asynchronously, and the voice and data channels have different latencies.

### BRIEF DESCRIPTION OF THE DRAWINGS

FIG. 1 is a diagram of a system that provides a push-to-talk function according to the invention;

FIG. 2 is a flow diagram of a prior art PTT single channel;

FIG. 3 is a flow diagram of a prior art PTT switched channel; and

FIG. 4 is a flow diagram of a prior art PTT multiplexed channel.

### DETAILED DESCRIPTION OF THE PREFERRED EMBODIMENT

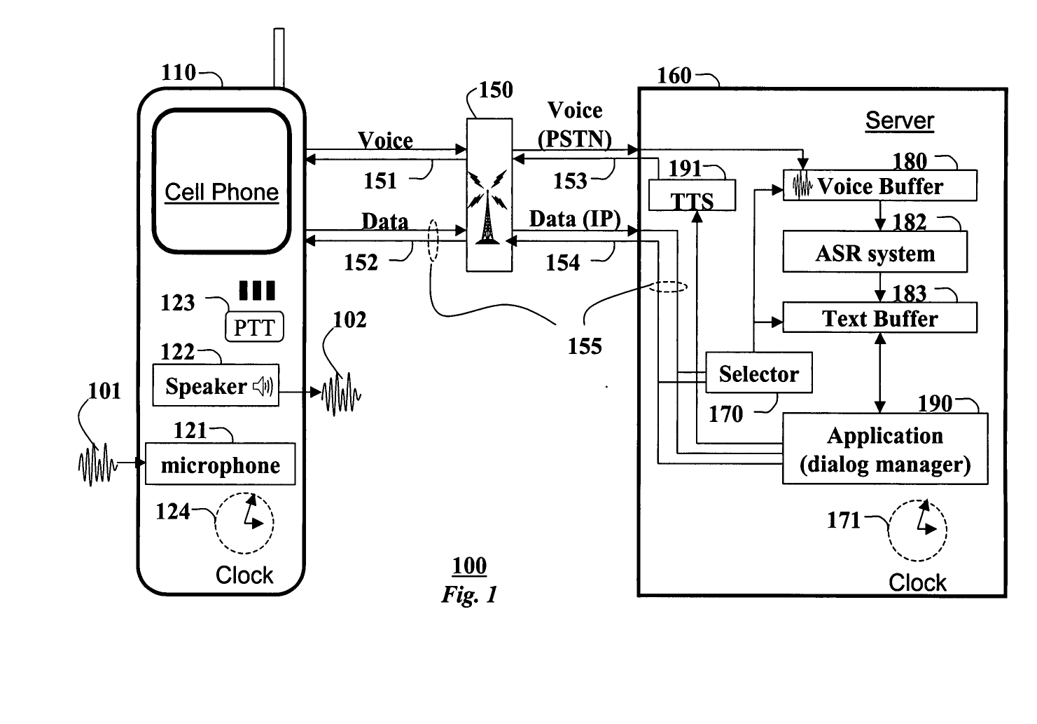

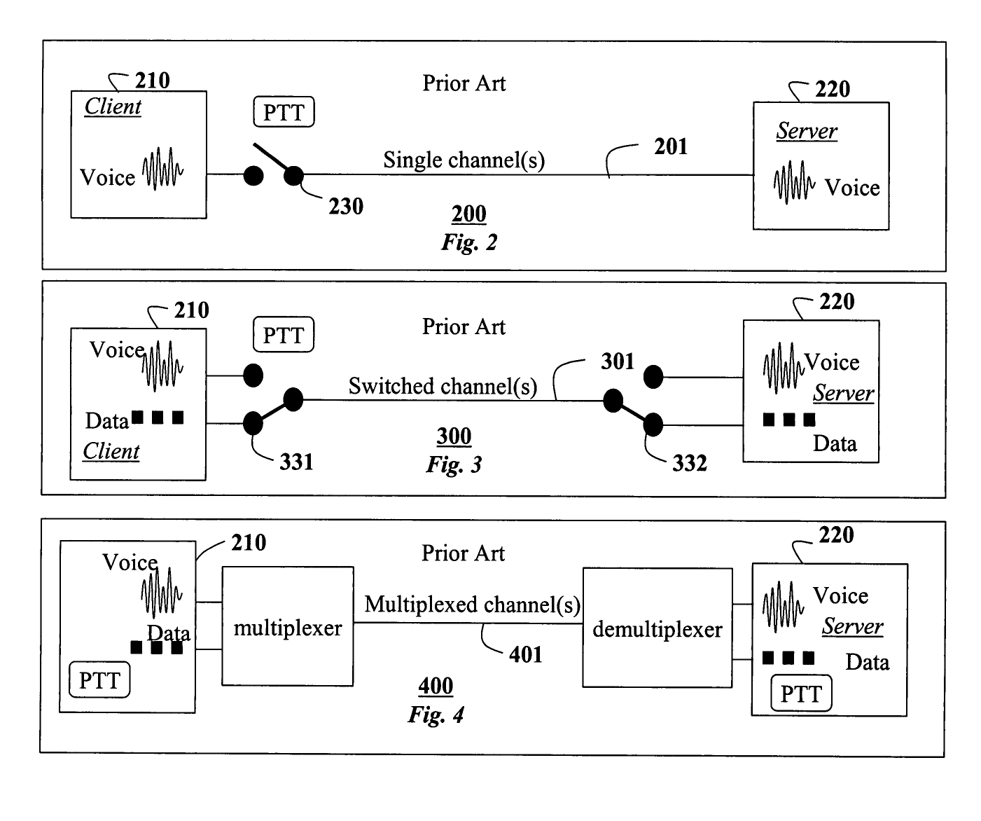

FIG. 1 shows a telephony system 100 that provides a push-to-talk (PTT) function according to the invention. The system 100 includes a cellular telephone (cell phone) 110 and a speech server 160 connected via a wireless network, e.g., a cellular network 150.

Network

The cellular network 150 supports a wireless voice channel 151 and a wireless data channel 152. The wireless voice channel provides a relatively low, fixed data rate connection with a low latency, usually considerably less than a second. This is necessary for two-way voice communications.

The wireless data channel provides a relatively high, variable data rate connection with a potentially a high latency, as much as tens of seconds. The latency of the wireless data channel varies because of communications with other devices in a cell, devices on the IP network, or server load.

The connections 153 and 154 between the cellular network and the server are usually wired. The public standard telephone network connection (PSTN) voice channel 153 is also low latency. Latencies on the wired data channel 154, e.g., the Internet, also vary due to changing routing and traffic conditions and server load. Therefore, various buffers of the server, described below, are sized according to inherent and unavoidable delays 155 in the data channels 152-154.

Cell Phone

The cell phone 110 includes a microphone 121 for speech input 101, a speaker 122 for audio output 102, a push-to-talk (PTT) button 123, and a clock 124.

The PTT button can be implemented as a ‘soft’ button, a ‘touch’ panel button, and the like. The cell phone also includes other buttons, such as alpha-numeric keys and control buttons. A selected one of these buttons can be designated the PTT button by programming the cell phone accordingly, perhaps using the conventional user interface that is provided with most cell phones for setting up user preferences or the button can be selected by the server.

However, the cell phone 110 lacks the ability to provide the PPT function itself, and the cell phone does not provide an application interface (API) for the cell phone application programs to intermittently enable and disable the voice channel as is done in conventional PTT devices. Typically, the cell phone microphone is always ‘on.’

PTT Events

Instead, pushing and releasing the PTT button 123 causes the cell phone to generate PTT ‘on’ and ‘off’ events. The PTT events are time-stamped according to a value of the clock 124 when the PTT button is pressed or released. The events and time-stamps are transmitted from the client to the server as data messages on the data channel.

Server

Voice signals and data messages received by the server from the client via the voice and data channels are processed by the speech server 160. The voice signal is stored in an voice buffer 180. Each audio sample of the voice signal in the voice buffer can be related to the time the sample was received.

Selected segments of the voice signal are processed by an automated speech recognition (ASR) system 182. Only those segments of the voice signal between a pair of ‘on’ and ‘off’ events are processed. The time-stamps can be used to accurately locate such segments.

However, it should be noted that other speech processing techniques can be used instead or in addition to the time-stamp events. For example, an ASR end pointing system can detect the start of speech that is substantially concurrent with the ‘on’ event, and the end of speech that is substantially concurrent with the immediately following ‘off’ event.

Segments of recognized speech are stored in a text buffer 183. The converted speech can have any known format. An application 190, under control of a selector 170, can process the text. For example, the application is a dialog manager of a voice query system.

A selector 170 receives the PTT events and synchronizes the events according to the server clock 171. Techniques for remotely synchronizing clocks and for correcting for clock drift are well known.

The events are used to access segments of the voice signal in the voice buffer 180 to be used by the ASR system 182, or to select text from the text buffer 183, which preserves the time-stamps.

The application 190 also receives the PPT events, which the application uses to control the operation of a text-to-speech engine (TTS) 191. The output speech signal of the application is in response to the input voice signal.

In this case, the PTT button can be used to control the feedback from the server. The button can also activate a short tone. This prevents distractions and miscommunications that might otherwise result because the cell phone and the ASR system and application operate asynchronously, and the voice and data channels have different latencies.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for processing a voice signal in a network, comprising:
transmitting, in a client, speech as a continuous voice signal over a voice channel of a network to a server;
generating, in the client, events, the events including on events and off events;
transmitting, in the client, the events as a data signal over a data channel of the network to the server;
converting, in the server, only segments of the voice signal that substantially correspond to a particular on event and a following off event.

2. The method of claim 1, further comprising:
time-stamping, in the client, each event according to a client clock.

3. The method of claim 2, further comprising:
time-stamping, in the server, the voice signal according to a server clock.

4. The method of claim 1, in which the client is a cellular telephone, and the network is cellular.

5. The method of claim 1, further comprising:
generating the events with a soft button.

6. The method of claim 1, further comprising:
generating the events with a hard button.

7. The method of claim 1, further comprising:
generating the events with a touch panel.

8. The method of claim 2, further comprising:
storing, in the client, the voice signal in a voice buffer.

9. The method of claim 1, further comprising:
generating, in the server, a speech signal in response to the converted voice signal; and
transmitting the speech signal to the client over the voice channel.

10. The method of claim 1, in which the voice signal is converted to text.

11. The method of claim 10, further comprising:
processing the text with a dialog manager.

12. The method of claim 1, in which the voice channel and the data channel have different bandwidth and latency characteristics.

13. The method of claim 1, further comprising:
synchronizing the client clock and the server clock.

14. The method of claim 1, further comprising:
generating, in the server, a tone for the client.

15. A push-to-talk telephony system, comprising:
a cell phone configured to transmit a continuous voice signal over a voice channel of a network, the cell phone further comprising:
means for generating events, the events including on events and off events; and
means for transmitting the events as a data signal over a data channel of the network; and
a server configured to convert only segments of the voice signal that substantially correspond to a particular on event and a following off event.

16. The system of claim 15, in which the voice signal is converted to text by an automated speech recognition system.

17. The system of claim 15, further comprising:
means for generating a speech signal in response to the converted voice signal.
